(19) United States
(12) Patent Application Publication
(10) Pub. No.: US 2011/0268931 A1
(43) Pub. Date: Nov. 3, 2011

(54) SPECIAL EFFECT GLAZING

(75) Inventors: Eric F.J.M. van der Meulen, Wixom, MI (US); Sunitha Grandhee, Novi, MI (US); Christophe Lefaux, Ann Arbor, MI (US); Keith D. Weiss, Fenton, MI (US)

(73) Assignee: EXATEC, LLC, Wixom, MI (US)

(21) Appl. No.: 12/990,320

(22) PCT Filed: May 2, 2008
(86) PCT No.: PCT/US08/62466

§ 371 Date: Oct. 29, 2010

(51) Int. Cl. B32B 3/00

(52) U.S. Cl. 428/195.1

(57) ABSTRACT

Disclosed is a transparent plastic automotive panel comprised of a plastic substrate, a non-black ink overlying a portion of the plastic substrate forming a printed substrate and a protective coating system overlying the ink. Also disclosed is a transparent plastic automotive panel comprised of a plastic substrate, a non-black ink overlying a portion of the plastic substrate forming a printed substrate and a protective coating system overlying the ink further comprising a plastic film, the ink being printed on a portion of the film

### BACKGROUND OF THE INVENTION

A new trend in the automotive industry is to have a smooth transition between different parts of the car. For instance, not so long ago, almost all automobiles had chrome bumpers that were separate and distinct from the body of the vehicle. Today, bumpers are integrated with the body in the design of the car and exhibit the same color as the car body. To create more dynamic-looking automobiles, manufacturers are using ever-increasing amounts of special-effect pigments. Technology-based colors, such as those that create a liquid-metal effect or sparkle, and nature-based colors, such as calming neutrals, cool blues and warm browns, are driving automotive color trends worldwide.

Automotive designers understand that a keen awareness of future trends in a consumer's color preference is essential to developing a successful palette for their car and truck lines. The colors they select must not only give their vehicles identity and distinction on the road, but must also appeal to the broadest number of car buyers. Thus, further processes for enhancing customer appeal are needed.

### BRIEF SUMMARY OF THE INVENTION

The present invention provides for transparent plastic automotive panels which are printed with an image or images using special effects ink. The transparent plastic automotive panels of the present invention are particularly useful for imparting a distinctive aspect to plastic glazings such as windows, headlamps and tail lights, for use in automobiles. The transparent plastic automotive panels of the present invention may be used to provide smooth transition between different parts of the automobile body and the plastic glazings by printing images using special effect inks that match or complement the color used for the body of the car. The transparent plastic automotive panels of the present invention may also provide for an image that appears continuous with an image on a separate plastic panel or a portion of the body of the automobile.

In one aspect, the invention is a transparent plastic automotive panel comprising a plastic substrate, a non-black ink overlying a portion of the plastic substrate forming a printed substrate and a protective coating system overlying the ink.

In another aspect, the invention is a panel comprising a plastic substrate, a non-black ink overlying a portion of the plastic substrate forming a printed substrate and a protective coating system overlying the a multi-layer system wherein the inks are selected from the group of opaque colored ink, translucent ink, special effect ink and any combination thereof.

In another aspect, the invention is a panel comprising a plastic substrate printed with at least one special effect ink.

In a further aspect, the invention is a panel comprising a plastic substrate, a non-black ink overlying a portion of the plastic substrate forming a printed substrate and a protective coating system overlying the ink, and further comprises a plastic film where the ink is printed on a portion of the film. The printed film may be bonded to the substrate. The ink on the printed film is encapsulated between the substrate and the film.

In another aspect, the invention is a panel comprising a plastic substrate, a non-black ink overlying a portion of the plastic substrate forming a printed substrate and a protective coating system overlying the ink and further comprising a plastic film where the ink is printed on a portion of the film and the ink is encapsulated between the film and the substrate.

In another aspect, the invention of the film is printed with an ink that includes a special effect ink.

In another aspect of the invention, the film is printed with a color varying ink.

In another aspect of the invention, the film is printed with a metallic ink.

In another aspect of the invention, the film is printed with an ink that includes a special effect which includes a pearlescent pigment, a metallic pigment, or any combination of both.

In another aspect of the invention, the special effect ink is a thermal heat cure ink or a UV cure ink.

In another aspect of the invention, the panel is a window.

In another aspect of the invention, the panel is incorporated into an automotive vehicle, the automotive vehicle having a body and the body of the automotive vehicle being of a color corresponding to the ink.

In one aspect, the invention is a transparent plastic automotive panel, a plastic substrate, a non-black ink overlying a portion of the plastic forming a printed substrate and a protective coating system overlying the ink.

In another aspect, the substrate is printed with an ink that includes a special effect ink.

In another aspect, the substrate is printed with an ink that includes a color varying ink.

In another aspect, the substrate is printed with an ink that includes a metallic ink.

In another aspect, the substrate is printed with an ink that includes a pearlescent pigment a metallic pigment, or a combination of both.

In another aspect, the protective coating system includes a weathering layer.

In another aspect, the protective coating system includes an abrasion resistant layer overlying a weathering layer.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIGS. 1-9 are cross sectional views of a plastic automotive panel of the present invention.

### DETAILED DESCRIPTION OF THE INVENTION

As used herein, the term “automobile” means any of a number of types of vehicles powered by a self contained or remote power plant which can be taken to include but are not limited to at least one of passenger cars, vans and motorcycles, light trucks, heavy duty trucks including off road vehicles, recreational vehicles such as mobile homes and campers, mass transit vehicles such as buses, locomotive vehicles such as trains and other light rail vehicles such as monorails and the like, as well as marine and aircraft. Similarly “automotive” is used as an adjective to indicate that the thing described relates to any “automobile.”

The term “ink” means a composition comprising one or more pigments.

The term “special effect pigment” refers to a variety of pigments which impart optical effects including, but not limited, to sparkle, luster, glitter, color variation, color intensity variation, pearlescence, or any combination of these effects. These effects occur when the surface, to which such a pigment is applied, is viewed from a different angle and/or with a different angle of illumination. Special effect pigments include, but are not limited to, metallic pigments and pearlescent pigments. For example, Engelhard's Mearlite industrial-grade pearlescent pigments impart a range of optical effects, from a soft, satin luster to a sharp, metallic brilliance. These effects are due to plate-like crystals of bismuth oxychloride that have a silver-white transparent appearance.

As used herein “special effect ink” means an ink which comprises a one or more special effect pigments. A special effect ink may additionally comprise one or more colored pigments.

“Three dimensional” or “3D” means not planar.

The present invention provides for the printing of images onto the surface of plastic substrates with special effect ink. The image is generally printed directly onto the surface of the plastic substrate. Plastic substrates include plastic plaques, plastic sheets, or molded plastics or sheet plastic film, wherein film means a thin flexible plastic. The plastic may comprise any thermoplastic or thermoset polymeric resin, such as but are not limited to, polycarbonate, acrylic, polyarylate, polyester, and polysulfone, as well as copolymers and mixtures thereof. The plastic substrates may be formed through the use of any technique known to those skilled in the art, such as molding, thermoforming, or extrusion.

The plastic substrate of the invention may be from about 0.02 to about 2.5 square meters, or from about 0.02 to about 0.2 square meters, or from about 0.06 to about 0.8 square meters, or from about 0.3 to about 1.6 square meters, or from about 1 to about 2.5 square meters.

The plastic substrate may be from about 2.5 mm to about 6 mm thick or from about 3.5 mm to about 6 mm thick or from about 3 mm to about 5 mm thick.

The plastic substrates may be planar or three dimensional (3-D), where three dimensional refers to any geometry that is not substantially planar. Processes of printing on three dimensional plastic surfaces are known by those of skill in the art, for example, U.S. Pat. Nos. 6,834,582, 6,698,345, 6,776,100, and 7,182,019.

Colored inks and special effect inks can be can be applied by screen printing, inkjet printing, pad printing, mask & spray, spray coating, or other techniques known to those skilled in the art. These inks can also be curable by any appropriate processes such as by air drying, UV absorption, thermal absorption.

The special effect ink, colored ink or combinations thereof may be generally printed directly on the plastic substrate. When the plastic substrate is molded plastic, or a plastic plaque, a protective coating system may then be applied to the substrate. When the plastic substrate is a film (a flexible, thin plastic sheet), the printed film is placed into the cavity of a mold and the plastic substrate is back molded onto the film, thereby encapsulating the ink between the film and the substrate. Generally, this molding process with film is known to those skilled in the art as film insert molding (FIM). The molded plastic substrate is removed from the mold, inspected, and any preliminary processing is carried out such as cleaning, which includes the elimination of static electrical charges. A protective coating system may then be applied to the molded substrate and film. The protective coating system may include a weathering layer followed by an abrasion resistant layer or either individually applied to the product.

The weathering layer may be applied by various means, including dipping the plastic substrate in the coating at room temperature and atmospheric pressure in a process known in the art as dip coating. Alternatively, the weathering layer may be applied by flow coating, curtain coating, spray coating, or other processes known to those skilled in the art.

The weathering layer may be comprised of but not limited to silicones, polyurethanes, acrylics, polyesters, polyurethane-acrylates, and epoxies, as well as mixtures or copolymers thereof. The weathering layer preferably includes ultraviolet (UV) absorbing molecules, such as hydroxyphenyltriazine, hydroxybenzophenones, hydroxylphenylbenzotriazoles, hydroxyphenyltriazines, polyaroylresorcinols, and cyanoacrylates, among others.

The weathering layer may be one homogenous layer or be comprised of multiple sub-layers, such as a primer and a topcoat. A primer typically aids in adhering the topcoat to the plastic panel. The primer for example may include, but not be limited to, acrylics, polyesters, epoxies, and copolymers and mixtures thereof. The topcoat may include, but not be limited to, polymethylmethacrylate, polyvinylidene fluoride, polyvinylfluoride, polypropylene, polyethylene, polyurethane, silicone, polymethacrylate, polyacrylate, polyvinylidene fluoride, silicone hardcoat, and mixtures or copolymers thereof. One specific example of a weathering layer comprising multiple sub-layers is the combination of an acrylic primer (SHP401 or SHP470, Momentive Performance Materials, Waterford, N.Y.) with a silicone hard-coat (AS4000 or AS4700, Momentive Performance Materials).

A variety of additives may be added to either or both the primer and the topcoat, such as colorants (tints), rheological control agents, mold release agents, antioxidants, and IR absorbing or reflecting pigments, among others. The type of additive and the amount of each additive is determined by the performance required by the plastic panel to meet the specification and requirements for use in any selected application, such as an automobile window including but not limited to side windows, windscreens, backlites and panorama sunroofs.

As noted above, the weathering layer may be over-coated via the deposition of an abrasion resistant layer. This abrasion resistant layer may be either comprised of one layer or a combination of multiple interlayers of variable composition. The abrasion resistant layer is a substantially inorganic coating that adds additional or enhanced functionality to the automotive decorative glazing assembly by improving abrasion resistant.

Specific examples of possible inorganic coatings for the abrasion resistant layer include, but are not limited to, aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, hydrogenated silicon oxy-carbide, tantalum oxide, titanium oxide, tin oxide, indium tin oxide, yttrium oxide, zinc oxide, zinc selenide, zinc sulfide, zirconium oxide, zirconium titanate, or glass, and mixtures or blends thereof.

The abrasion resistant layer may be applied by any technique known to those skilled in the art. These techniques include deposition from reactive species, such as those employed in vacuum-assisted deposition processes, and atmospheric coating processes, such as those used to apply sol-gel coatings to substrates. Examples of vacuum-assisted deposition processes include, but not limited to, plasma enhanced chemical vapor deposition (PECVD), arc-PECVD, ion assisted plasma deposition, magnetron sputtering, electron beam evaporation, and ion beam sputtering. Examples of atmospheric coating processes include, but are not limited to, curtain coating, spray coating, spin coating, dip coating, and flow coating.

As used herein “special effect ink” means an ink which comprises a one or more special effect pigments. A special effect ink may additionally comprise one or more colored pigments.

A wide variety of colored inks are known and one of skill in the art would know how to make a particular color. Briefly the full range of colors can be made with different combinations of three basic colors. Media that combines emitted light to create the sensation of a range of colors uses this type of additive color system. In an additive color system, the additive primary colors are red, green, and blue. Additive mixing of red and green light produces shades of yellow or orange, mixing green and blue produces shades of cyan, and mixing red and blue produces shades of purple and magenta. Mixing equal proportions of the additive primary colors results in shades of grey. When all three colors are fully saturated, the resultant color is white. The color space that is generated is called the RGB (“red, green, blue”) color space. Colored inks are compatible with the processes of the present invention and can be used to create a smooth visual transition from the car body to the glazing area.

An example of a colored ink formulation suitable for use with a plastic film insert molding (FIM) process) is Noriphan™ HTR with 50% Opaque White (code 945), 35% Blue transparent (code 566), and 22% Violet (code 472) offered by Proell, Inc., St. Charles, Ill. It is noted that a retarder (e.g., slow evaporating solvent) has to be added prior printing on a film.

Usually, special effect pigment colors are doubled printed and backed with a highly opaque black print although other processes of printing known to those skilled in the art are acceptable. The term “special effect pigment” refers to a variety of pigments which impart optical effects including but not limited to sparkle, luster, glitter, color variation, color intensity variation, pearlescence, or any combination of these effects. These effects occur when the surface to which such a pigment is applied, is viewed from a different angle and/or with a different angle of illumination.

Special effect pigments include but are not limited to metallic pigments and pearlescent pigments. For example, Mearlite® (Engelhard-BASF) industrial-grade pearlescent pigments impart a range of optical effects, from a soft, satin luster to a sharp, metallic brilliance. These effects are due to plate-like crystals of bismuth oxychloride that have a silver-white transparent appearance. A wide variety of special effect pigments are known including, but not limited to chameleon gold-green, chameleon green-blue, pearlescent blue, solar gold, pearlescent magenta-gold, chameleon copper-green, chameleon purple-green, chameleon green-purple, pearlescent green, and pearlescent lilac.

Special effects pigments also include metallic pigments, for example, silver, silver-gold, aluminum, bronze, and gold. Metallic pigments are, by nature, completely different than other types of pigments used in printing. These pigments are flake-shaped, fully opaque and significantly larger. They consist of planar areas designed to reflect as much light as possible in order to create metallic sheen or luster. Metallic pigments are produced in a variety of particle sizes. The larger the flake size, the greater the degree of brilliance. Metallic flakes used in the graphic arts industry vary from 3 to 15 μm. Aluminum pigments can be produced by a variety of means. The conventional process of producing aluminum pigments found in the graphic arts industry is by the wet grinding process (Hall process). The conventional process of producing bronze pigments in the graphic arts industry is by a dry grinding process (Hametag process). Other means of production, such as stamping and physical vapor deposition, can produce flatter and therefore more brilliant products.

Pearlescent finishes are also used in the glazing industry. These finishes are designed to create color through light interference effects. They are comprised of a thin layer of a metal oxide deposited on a supporting mica flake. The thickness of the metal oxide layer is such that a specific wavelength of light is reinforced, the lightness changes are accompanied by marked changes in hue and saturation that creates a pearlescent appearance. The metal oxide chosen may also provide color through light absorption.

Windows in the automotive industry typically exhibit a black-out area that encircles the edge of the window in order to mask and hide the bonding system that glues the window to the car body. Instead of printing this highly opaque black ink, one embodiment of the present invention provides this layer as an ink that exhibits a special effect (e.g., color varying, metallic sparkle, etc.) due to the special pigments incorporated into the ink. Another embodiment of the invention provides a process of printing which result in an image having a shadow effect that gives the image a 3-D appearance. This shadow effect may be provided by printing part of the area of the image using one or more special effect inks and printing parts of the area of the image using standard colored inks. In another embodiment this shadow effect is provided by printing a layer of halftones or shadings of colored ink over a layer of one or more special effect inks. “Halftone” means the image that is produced through the use of equally spaced dots of varying size.

In another embodiment of the present invention, a plastic film is printed with one or more prints and then placed inside a mold cavity and over-molded. In yet another embodiment of the invention, the special effect inks are printed directly onto the plastic substrate. In another embodiment of the invention, the substrate is coated with a weathering layer followed by the deposition of an abrasion resistant layer, prior to the printing of the special effect ink. As will be appreciated from the discussions herein, the processes of the invention are suitable for use to print images over large areas including, but not limited to automotive windows.

In addition to borders and black-out features, the processes of the present invention can be used to add one or more images to a plastic substrate for example: letters, symbols, numbers, logos, trademarks, regulatory designations, emblems, chrome strips, chrome accents, and reflectors. The images may for example be printed on different areas of the plastic substrate and/or they may be printed with separate images layered on top of one and other.

Referring now to the figures, the transparent plastic automotive panel of the present invention is generally designated at 20. As its primary components the panel may include an exterior abrasion resistant layer 30, an exterior weathering layer 40, a plastic substrate 50, a printed ink 60, a film 70, an interior weathering layer 80, and an interior abrasion resistant layer 90. The plastic substrate has an exterior side 110 and an interior side 120, wherein the terms exterior and interior correlate to the intended exterior and interior sides of an automobile into which the panel 20 may be incorporated.

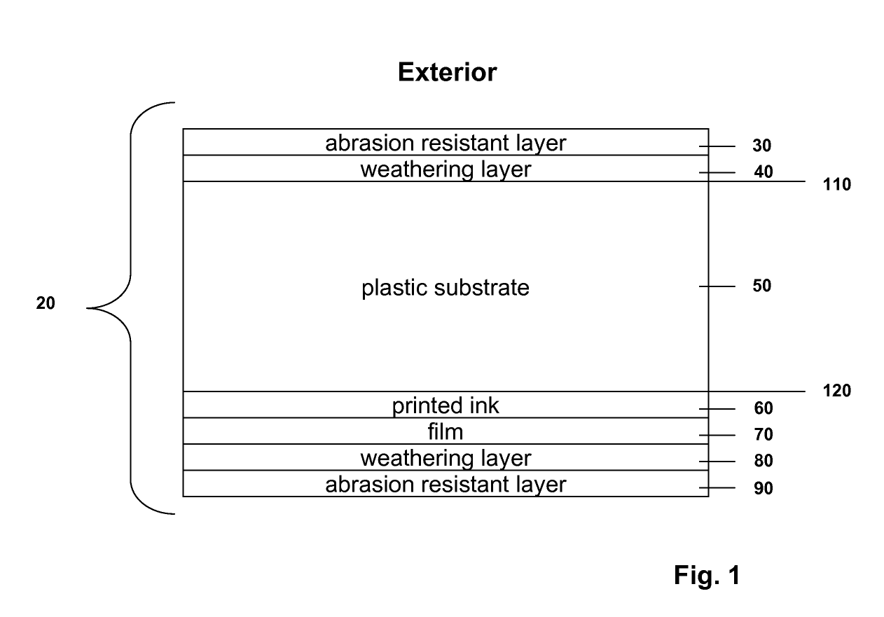

Referring now to FIG. 1, shown therein is a cross section of a panel 20 of the present invention in which the plastic substrate 50 has on its exterior side 110 a weathering layer 40, and an abrasion resistant layer 30 which overlays the exterior weathering layer 40. The interior side 120 of the plastic substrate 50 is overlaid with printed ink 60 which is encapsulated by the plastic substrate 50 and the film 70. The film 70 is overlaid with an interior weathering layer 80, which in turn is overlaid with an interior abrasion resistant layer 90.

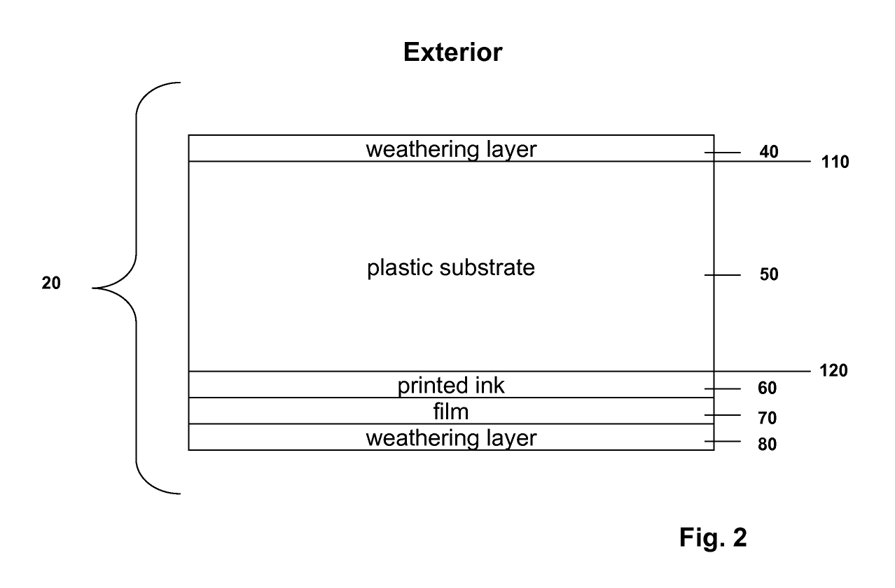

The embodiment of FIG. 2 shows a cross section of a panel 20 of the present invention in which exterior side 110 of the plastic substrate 50 is overlaid with just an exterior weatherable layer 40. The interior side 120 of the plastic substrate 50 is overlaid with printed ink 60 that is encapsulated by the plastic substrate 50 and the film 70. The interior film 70 is also overlaid with an interior weathering layer 80.

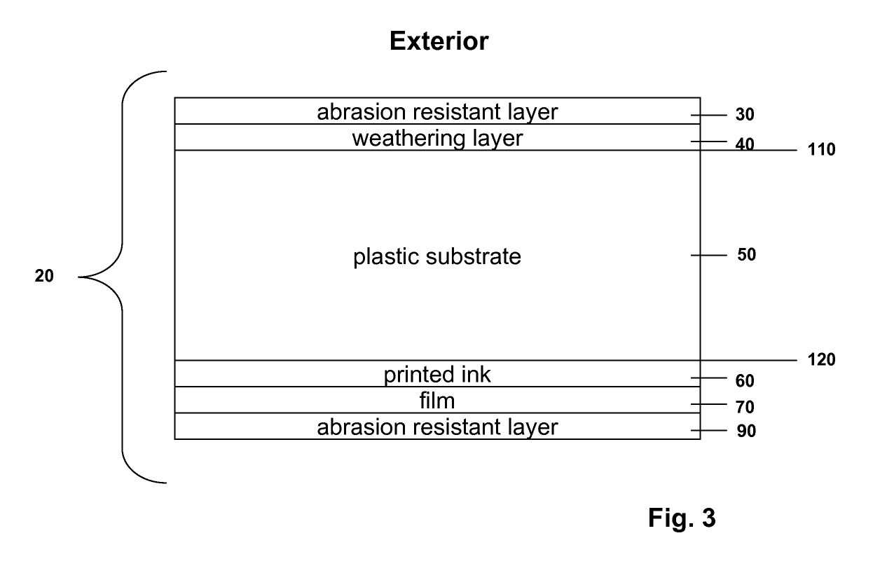

FIG. 3 shows a cross section of a panel 20 of the present invention in which the plastic substrate 30 has on its exterior side 110 a weathering layer 40 with an abrasion resistant layer 30 overlaying the weathering layer 40. The interior side 120 of the plastic substrate 50 is overlaid with printed ink 60, which is encapsulated by the plastic substrate 50 and the film 70. The film 70 is overlaid with just an interior abrasion resistant layer 90.

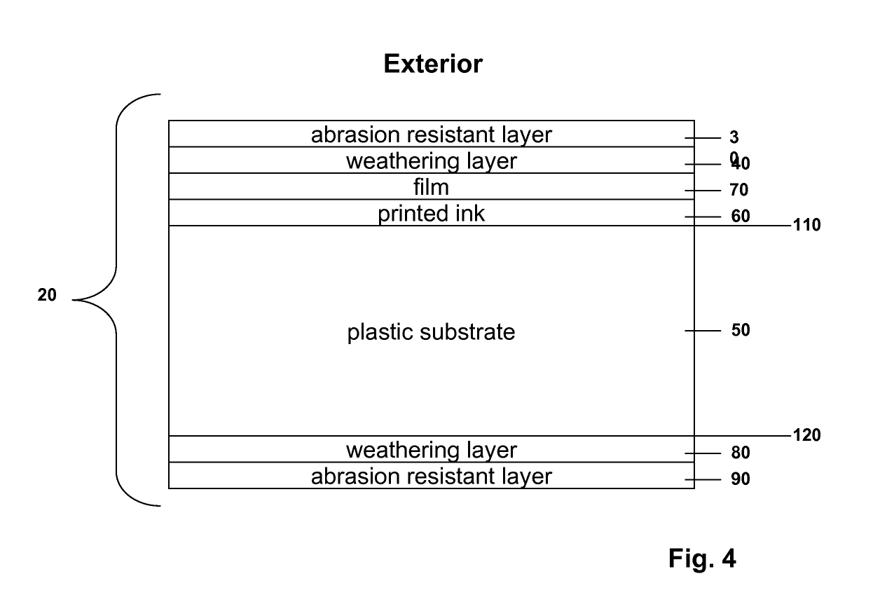

Shown in FIG. 4 is a cross section of a panel 20 of the present invention in which exterior side 110 of the plastic substrate 50 is overlaid with printed ink 60, which is encapsulated by the plastic substrate 50, and the film 70. The film 70 is overlaid with a weathering layer 40 that in turn is overlaid by an exterior abrasion layer 30. The interior side 120 of the plastic substrate 50 is overlaid by an interior weathering layer 80, which in turn is overlaid with an interior abrasion layer 90.

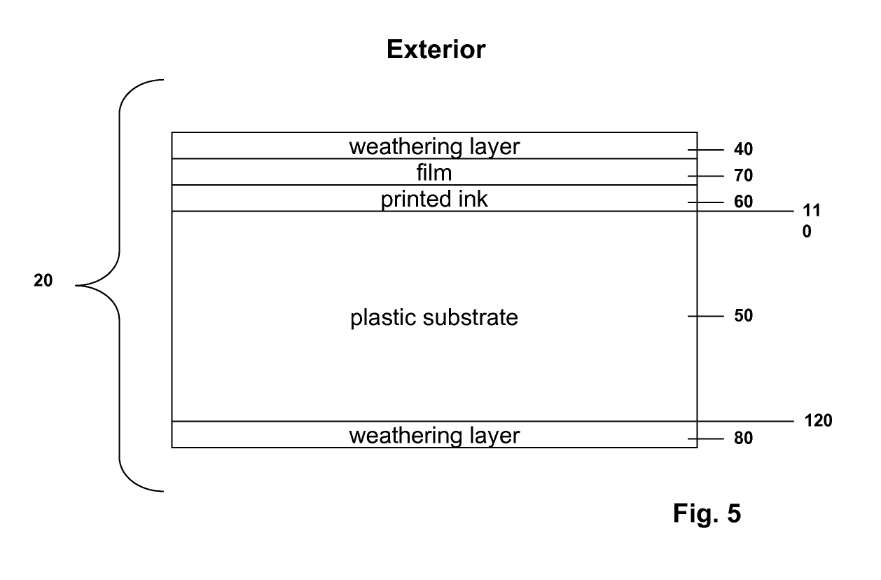

FIG. 5 shows a cross section of a panel 20 of the present invention in which the exterior side 110 of the plastic substrate 50 is overlaid with printed ink 60. The printed ink 60 is encapsulated between the substrate 50 and the exterior film 70. The film 70 is with an exterior weathering layer 40 that is in turn overlaid with an exterior abrasion layer 30. The interior side 12 of the plastic substrate 50 is overlaid with just an interior weathering layer 80.

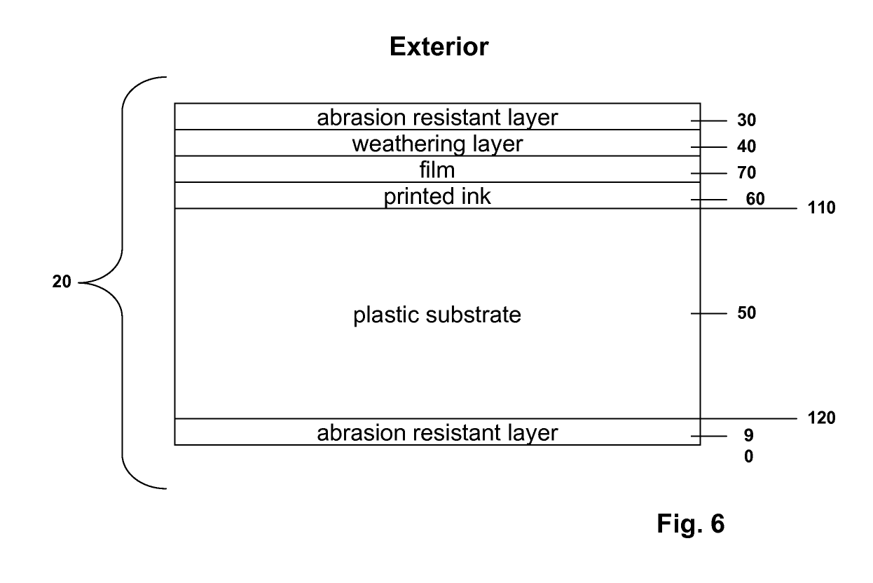

As seen in FIG. 6, a cross section of a panel 20 of the present invention is shown in which exterior side 110 of the plastic substrate 50 is overlaid with printed ink 60 that is encapsulated between the plastic substrate 50 and the film 70. The film 70 is overlaid with a weathering layer 40, which in turn is overlaid by an exterior abrasion layer 30. The interior side 120 of the plastic substrate 50 is solely overlaid by an interior abrasion resistant layer 90.

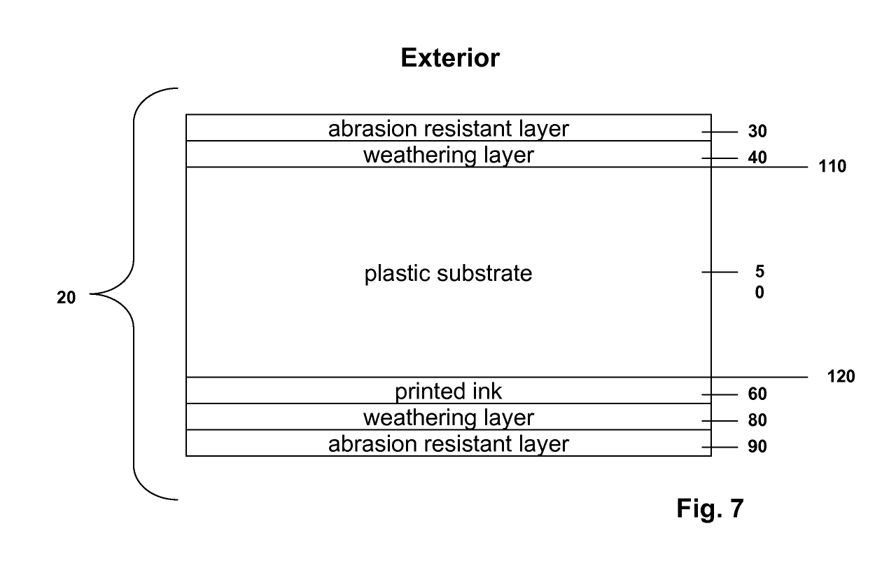

FIG. 7 shows a cross section of a panel 20 of the present invention in which the plastic substrate 50 has on its exterior side 110 a weathering layer 40, over which lies an abrasion resistant layer 30. The interior side 120 of the plastic substrate 50 is printed with the ink 60. Printed ink 60 is encapsulated between the plastic substrate 50 and the interior weathering layer 80, which is in turn overlaid by an interior abrasion resistant layer 90.

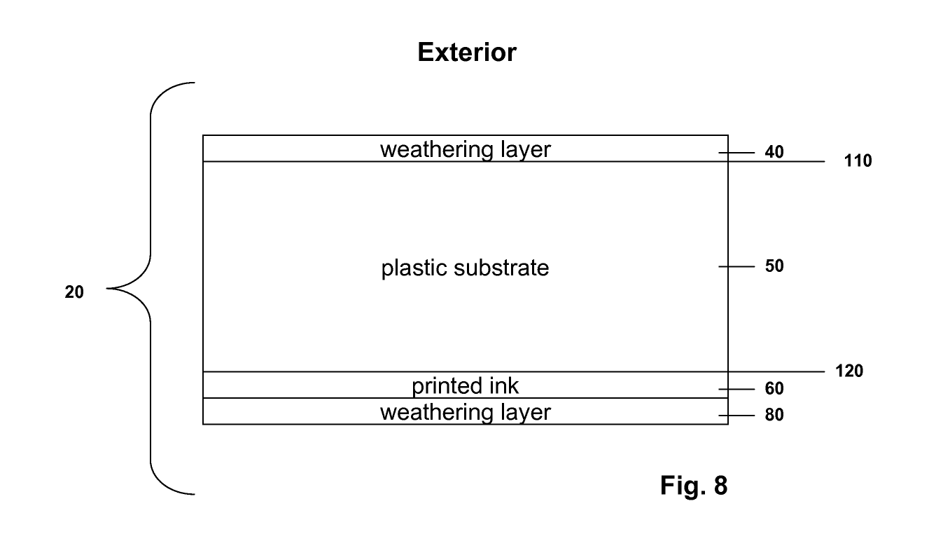

FIG. 8 shows a cross section of a panel 20 of the present invention in which the plastic substrate 50 has on its exterior side 110 just an exterior weathering layer 40. The interior side 120 of the plastic substrate 50 is printed with ink 60, which is encapsulated by the plastic substrate 50 and the exterior weathering layer 80.

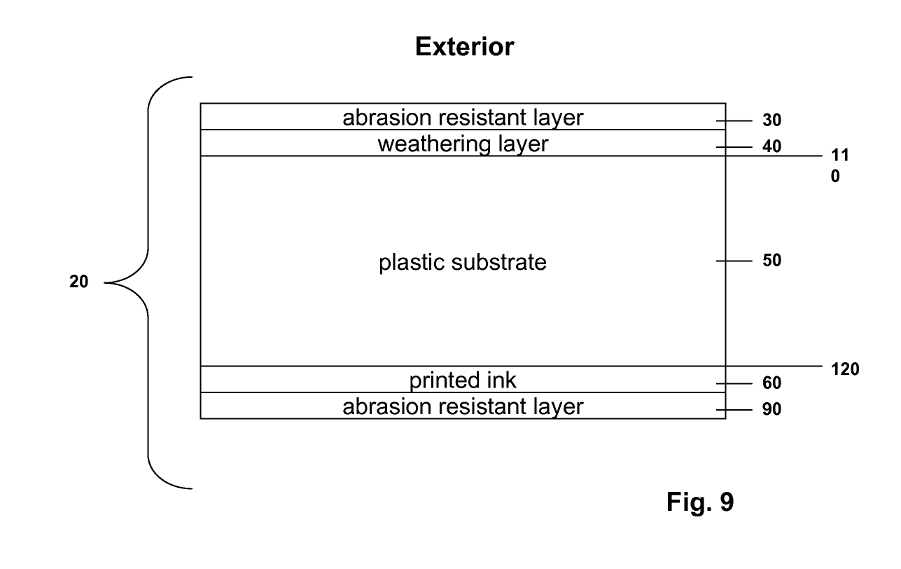

FIG. 9 shows a cross section of a panel 20 of the present invention in which the plastic substrate 50 has on its exterior side 110 a weathering layer 40 and an abrasion resistant layer 30, which overlays the weathering layer 40. The interior side 120 of the plastic substrate 50 is printed with ink 60 and printed ink 60 is encapsulated between plastic substrate 50 and interior abrasion resistant layer 90.

The following specific example is given to illustrate the invention and should not be construed to limit the scope of the invention.

### EXAMPLE

Logo with 3-Dimensional Effect

A white background for the logo was screen printed on a 0.6×1.2 m polycarbonate film of 0.76 mm thickness using white ink. A second image was printed with a chrome special effect ink on top of the background color. A third image was a gold colored logo inside the chrome image. A fourth image was printed using black ink to provide the 3-dimensional shadow effect.

All screens had 78 threads per centimeter mesh size. A 4 mm off-contact was used for printing. All inks were NORIPHAN® HTR inks (Proell, Inc., St. Charles, Ill.). Between each print the film was run through a 3-zone tunnel dryer at 70-90-80° C. to flash off solvents. After all four prints, the film was post cured in an oven for 5 hours at 90° C. After curing and cool down the film was trimmed to the size of the mold which was approximately 0.5×1.0 m, with a wall thickness of 4.8 mm. The film was placed in the mold and then the mold was injected with Lexan GLX143 polycarbonate resin (SABIC Innovative Plastics, Pittsfield, Mass.). The film can be positioned on either cavity of the mold. Thus the film with the printed images can end up on either the external or internal side of the window. FIG. 1 is a cross-section of a window with the film located on the exterior of the window according to one embodiment of the present invention. One skilled in the art will recognize that if the film was placed on the other side of the window (e.g., interior side of the substrate), the printed images would need to be printed or stacked in the opposite order so that the images viewed from the external side of the vehicle would be seen by an observer to be substantially similar.

The printed images and the plastic film become substantially bonded to the plastic substrate. After removal from the mold the resulting part was coated an acrylic primer (SHP-9X, Exatec LLC, Wixom, Mich.) and a weathering layer (SHX, Exatec LLC). An abrasion resistant layer was then deposited using an expanding arc PECVD technique. The resulting glazing system including the weathering layer and the abrasion resistant layer is known as the Exatec®900 coating system (Exatec LLC., Wixom, Mich.).

The preceding description is merely exemplary in nature and is in no way intended to limit the invention or its application or uses. A person skilled in the art will recognize from the previous description that modifications and changes can be made to the specifically described embodiments of the invention without departing from the scope of the invention as defined in the following claims.

1. A transparent plastic automotive panel comprising:
a plastic substrate, a non-black ink overlying a portion of the plastic substrate forming a printed substrate and a protective coating system overlying the ink.

2. The panel of claim 1 wherein the substrate in 3-dimensional.

3. The panel of claim 1 wherein the substrate is curved.

4. The panel of claim 1 wherein the panel is a window

5. The panel of claim 1 wherein the ink comprises a multi-layer system including and ink selected from the group of opaque colored ink, translucent ink, special effect ink and any combination thereof.

6. The plastic window assembly of claim 1 wherein the printed special effect ink is a thermal heat cure ink.

7. The panel of claim 1 wherein the ink is a UV cure ink.

8. The panel of claim 1 incorporated into an automotive vehicle, the automotive vehicle having a body and the body of the automotive vehicle being of a color corresponding to the ink.

9. The panel of claim 1 wherein the plastic substrate does not comprise a film.

10. The panel of claim 1 wherein the ink includes a special effect ink.

11. The panel of claim 10 wherein the special effect ink is a color varying ink.

12. The panel of claim 10 wherein the special effect ink is a metallic ink.

13. The panel of claim 10 wherein the special effect ink further comprises pigments selected from the group of pearlescent pigments, metallic pigments, or a combination of both.

14.-16. (canceled)

17. The panel of claim 1 further comprising a plastic film, the ink being printed on a portion of the film.

18.-24. (canceled)

25. The panel of claim 17 wherein the protective coating system overlying the ink includes a weathering layer.

26. The panel of claim 25 wherein the protective coating system includes an abrasion resistant layer overlying the weathering layer.

27. The panel of claim 17 wherein the protective coating system includes an abrasion resistant layer overlying the weathering layer.

28. (canceled)
